(19) United States
(12) Patent Application Publication
(10) Pub. No.: US 2026/0127100 A1
(43) Pub. Date: May 7, 2026

(54) DEVELOPMENT SUPPORT SYSTEM AND DEVELOPMENT SUPPORT DEVICE

(71) Applicant: Sony Interactive Entertainment Inc., Tokyo (JP)

(72) Inventor: Akito Ota, Tokyo (JP)

(73) Assignee: Sony Interactive Entertainment Inc., Tokyo (JP)

(21) Appl. No.: 19/339,065

(22) Filed: Sep. 24, 2025

(30) Foreign Application Priority Data
Nov. 6, 2024 (JP) 2024-194536

(51) Int. Cl. G06F 11/3668

(52) U.S. Cl. CPC G06F 11/3688

(57) ABSTRACT

There is provided a development support system including a source code management server that has a management area for managing source codes of system software, a ticket management server that manages a ticket describing contents of a defect of the system software, a test case management server that manages a plurality of test cases related to the system software, and, a development support device that has a memory and a processor.

### CROSS-REFERENCES TO RELATED APPLICATIONS

This application claims the benefit of Japanese Priority Patent Application JP 2024-194536 filed Nov. 6, 2024, the entire contents of which are incorporated herein by reference.

### BACKGROUND OF THE INVENTION

The present disclosure relates to a development support system and a development support device.

From the past, there has been known a program development support system that includes a version management server for managing source codes and test cases in units of versions, a ticket management server for managing contents related to work and a defect according to program creation as a ticket (slip), and an automatic execution processing server for automatically executing work according to program creation such as building and testing of source codes (for example, JP 2021-105866A).

In the program development support system described in JP 2021-105866A, an automatic execution processing change unit of the automatic execution processing server controls the execution order of execution target information stored in an automatic execution queue according to a priority and the number of days until a due date. The execution target information is one processing for automatic execution, and includes information for specifying a source code and a test code to perform automatic execution processing or actual conditions of the source code and test code. An automatic execution processing unit of the automatic execution processing server conducts building of the source code, a test using a test case, static analysis, and review. Then, a notification unit of the automatic execution processing server notifies persons concerned of the execution result by the automatic execution processing unit.

It should be noted that, in the program development support system, in a case where the status attribute of work is “working” such as at the time of correction, efficient automatic execution processing is executed each time a corrected source code is committed to the version management server. In addition, in a case where the status attribute of work is “work completion,” focused automatic execution processing is executed when the source code is committed to the version management server.

### BRIEF SUMMARY OF THE INVENTION

However, in the program development support system described in JP 2021-105866A, the above-described automatic execution processing is executed when the corrected source code is committed to the version management server. Since the corrected source code is committed to the version management server even if a test in the automatic execution processing has not been passed as described above, there is a problem that version management in the version management server becomes complicated.

Therefore, there has been a demand for a configuration in which source codes can be easily managed.

A development support system according to a first embodiment of the present disclosure includes a source code management server that has a management area for managing source codes of system software, a ticket management server that manages a ticket describing contents of a defect of the system software, a test case management server that manages a plurality of test cases related to the system software, and a development support device that has a memory and a processor and executes an automatic test based on at least one test case among the plurality of test cases, and the processor has a ticket acquisition unit that acquires, when a code in which a defect has been corrected among the source codes is stored in a place other than the management area, the ticket corresponding to the corrected code from the ticket management server, a test case acquisition unit that acquires a target test case related to a test of the corrected code among the plurality of test cases, an automatic test execution unit that executes the automatic test based on the target test case, a test result determination unit that determines whether the system software has passed the automatic test executed by the automatic test execution unit, and a corrected code storage unit that does not store the corrected code in the management area when it is determined by the test result determination unit that the automatic test has not been passed, and stores the corrected code in the management area when it is determined that the automatic test has been passed.

A development support device according to a second embodiment of the present disclosure includes a memory and a processor, and the processor includes a ticket acquisition unit that acquires, when a code in which a defect has been corrected among source codes configuring system software is stored in a place other than a management area, a ticket corresponding to the corrected code, a test case acquisition unit that acquires a target test case related to a test of the corrected code among a plurality of test cases, an automatic test execution unit that executes an automatic test based on the target test case, a test result determination unit that determines whether the system software has passed the automatic test executed by the automatic test execution unit, and a corrected code storage unit that stores the corrected code in the management area when it is determined by the test result determination unit that the automatic test has been passed.

### BRIEF DESCRIPTION OF THE DRAWINGS

FIG. 1 is a block diagram for depicting a configuration of a development support system according to a first embodiment of the present disclosure;

FIG. 2 is a diagram for depicting an example of a ticket according to the first embodiment of the present disclosure;

FIG. 3 is a diagram for depicting an example of a test case group according to the first embodiment of the present disclosure;

FIG. 4 is a block diagram for depicting a configuration of a development support device according to the first embodiment of the present disclosure;

FIG. 5 is a block diagram for depicting a functional configuration of a processor according to the first embodiment of the present disclosure;

FIG. 6 is a flowchart for depicting automatic test processing according to the first embodiment of the present disclosure;

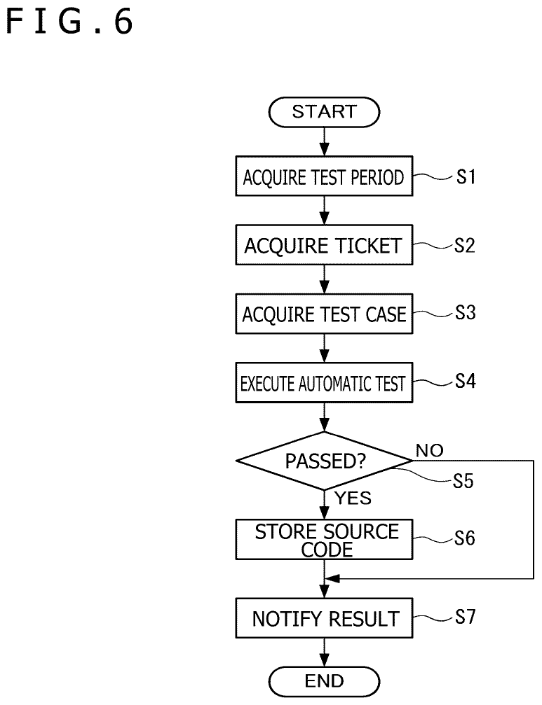

FIG. 7 is a block diagram for depicting a functional configuration of a processor of a development support device provided in a development support system according to a second embodiment of the present disclosure;

FIG. 8 is a diagram for depicting a test case group provided in a development support system according to a third embodiment of the present disclosure ; and

FIG. 9 is a flowchart for depicting test case acquisition processing according to the third embodiment of the present disclosure.

### DETAILED DESCRIPTION OF THE INVENTION

### First Embodiment

Hereinafter, a first embodiment of the present disclosure will be described on the basis of the drawings.

### Schematic Configuration of Development Support System

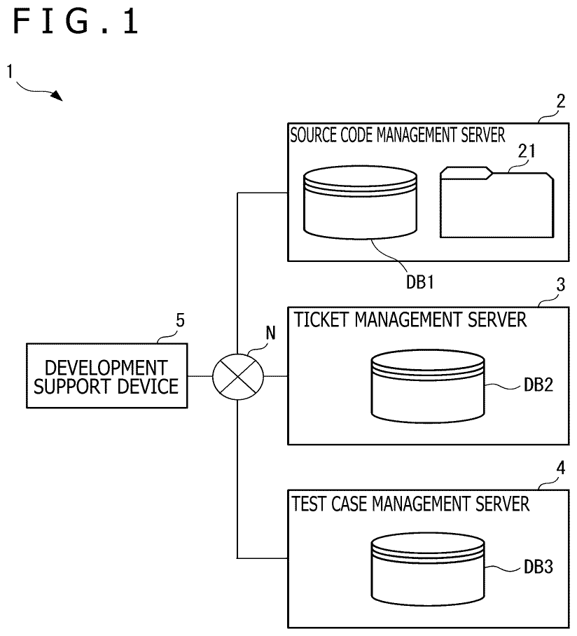

FIG. 1 is a block diagram for depicting a configuration of a development support system 1 according to the embodiment of the present disclosure.

As depicted in FIG. 1, the development support system 1 according to the embodiment of the present disclosure includes a source code management server 2 holding a source code management database DB1, a ticket management server 3 holding a ticket management database DB2, a test case management server 4 holding a test case management database DB3, and a development support device 5. The source code management server 2, the ticket management server 3, and the test case management server 4 are communicably connected to the development support device 5 via a network N. It should be noted that the network N may be a local area network (LAN) such as an in-house LAN or a public information communication network such as the Internet.

In the development support system 1, when a corrected code, which is a source code having corrected a defect, is applied to the source code management server 2 for managing source codes, the development support device 5 executes an automatic test of a test case related to the defect indicated by a ticket describing the defect. Then, in a case where the automatic test has succeeded, the development support device 5 stores the corrected code in the source code management database DB1. On the other hand, in a case where the automatic test has failed, the development support device 5 rejects the storage of the corrected code in the source code management database DB1 and notifies an operator or the developer of the development support device 5 of the fact that further correction of the source code is necessary.

Hereinafter, each configuration of the development support system 1 will be described in detail.

### Configuration of Source Code Management Server

The source code management server 2 holds the source code management database DB1 and an application folder 21.

The source code management database DB1 is a source code management area for managing source codes of system software to be tested. The source code management database DB1 stores, for example, a source code that has passed at least one of an automatic test and a manual test. More specifically, the source code management database DB1 stores a releasable source code.

The application folder 21 is a folder for applying for storing in the source code management database DB1 a corrected code that is a source code having corrected a defect input to a ticket TK described later. That is, the corrected code stored in the application folder 21 is the source code applied to be stored in the source code management database DB1. The corrected code is a target code to be subject to an automatic test by the development support device 5, and is stored in the application folder 21 as a file of a predetermined format. As described above, the application folder 21 is a place other than the management area. In the present embodiment, the application folder 21 is provided in the source code management server 2, but is not limited thereto, and may be provided in, for example, another server having a development environment, or may be provided in the development support device 5.

### Configuration of Ticket Management Server

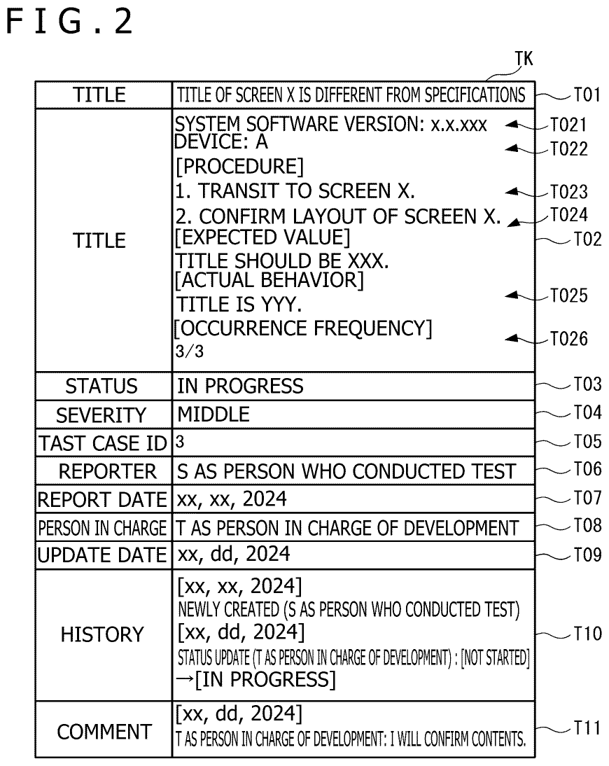

FIG. 2 is a diagram for depicting an example of a ticket TK used in the development support system 1.

The ticket management server 3 holds the ticket management database DB2.

The ticket management database DB2 is a ticket management area for managing a ticket describing a defect having occurred in the system software to be tested. For example, the ticket management database DB2 manages the ticket TK depicted in FIG. 2 as an example.

As described above, the ticket management server 3 is communicably connected to the development support device 5 via the network N. Therefore, the development support device 5 can refer to the ticket TK managed by the ticket management database DB2 by accessing the ticket management server 3.

### Configuration of Ticket

Here, the ticket TK will be described.

In the development support system 1, for example, the ticket TK depicted in FIG. 2 as an example is used. The ticket TK is issued in a case where a defect is found in a manual test or an automatic test of the system software, and information related to the defect is described.

The ticket TK includes a title field T01, a content field T02, a status field T03, a severity field T04, a test case field T05, a reporter field T06, a report date field T07, a person-in-charge-of-development field T08, an update date field T09, a history field T10, and a comment field T11.

The title field T01 is a place for inputting and displaying an outline of the defect.

The content field T02 is a place for inputting and displaying the contents of the defect. The content field T02 includes, for example, a version field T021, a device field T022, a reproduction procedure field T023, an expected value field T024, a behavior field T025, and an occurrence frequency field T026.

The version field T021 is a place for inputting and displaying the version of the system software where the defect occurred.

The device field T022 is a place for inputting and displaying information for identifying the device where the test in which the defect occurred was conducted. In the example of FIG. 2, the number assigned to the device is written in the device field T022.

The reproduction procedure field T023 is a place for inputting and displaying a procedure for reproducing the defect that occurred.

The expected value field T024 is a place for inputting and displaying an expected value in a case where the reproduction procedure input in the reproduction procedure field T023 is conducted. That is, the expected value field T024 is a place for inputting and displaying a normal result in a case where the reproduction procedure is conducted.

The behavior field T025 is a place for inputting and displaying an actual behavior in a case where the reproduction procedure written in the reproduction procedure field T023 was conducted. That is, the behavior field T025 is a place for inputting and displaying the contents of the defect when the reproduction procedure was executed.

The occurrence frequency field T026 is a place for inputting and displaying the occurrence frequency of the defect in a case where the reproduction procedure was conducted. In the example of FIG. 2, the occurrence frequency is indicated by a fraction in which the number of executions of the reproduction procedure is the denominator and the number of occurrences of the defect is the numerator. However, the present disclosure is not limited thereto, and the occurrence frequency may be indicated by a percentage.

The status field T03 is a place for inputting and displaying the handling status of the defect indicated by the ticket TK. In the ticket TK depicted in FIG. 2, “in progress” is written in the status field T03. The “in progress” indicates that the correction of the defect indicated by the ticket TK is being handled. It should be noted that “not started” indicates that the correction of the defect has not been started, and “completed” indicates that the correction of the defect has been completed.

The severity field T04 is a place for inputting and displaying the severity of the defect indicated by the ticket TK. The severity of the defect is represented by, for example, “large,” “medium,” and “small.” A severity of “high” indicates that the defect is severe and the function may not be used without correction. A severity of “medium” indicates that it is inconvenient without correction. A severity of “low” indicates that the defect is minor.

The test case field T05 is a place for inputting and displaying a test case identification (ID) related to the defect indicated by the ticket TK.

The reporter field T06 is a place for inputting and displaying the name of the reporter who reports the defect.

The report date field T07 is a place for inputting and displaying the date when the defect is reported.

The person-in-charge-of-development field T08 is a place for inputting and displaying the name of the person in charge who created the source code causing the defect.

The update date field T09 is a place for inputting and displaying the date when the contents of the ticket TK were updated.

The history field T10 is a place for inputting and displaying the history of the defect indicated by the ticket TK.

The comment field T11 is similar to a remarks field and is a place for inputting and displaying comments related to the defect indicated by the ticket TK. For example, as depicted in FIG. 2, it is possible to input a comment related to the handling status of the defect in the comment field T11, and it is also possible to input a correction state of the defect.

### Configuration of Test Case Management Server

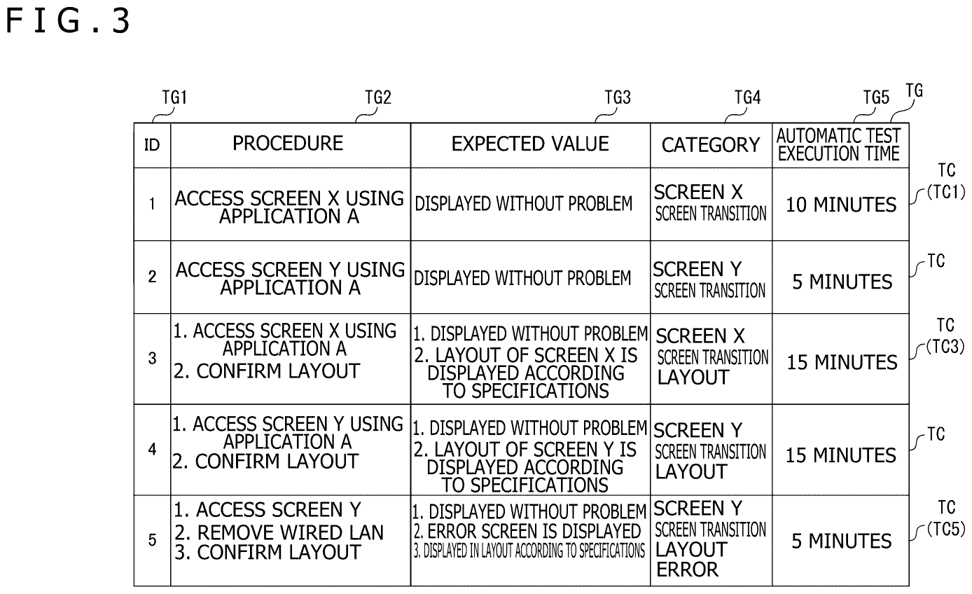

FIG. 3 is a diagram for depicting an example of a test case group TG.

The test case management server 4 depicted in FIG. 1 holds the test case management database DB3.

The test case management database DB3 manages a test case group including a test case of the system software to be tested. For example, the test case management database DB3 manages the test case group TG depicted in FIG. 3 as an example.

### Configuration of Test Case Group

Here, the test case group TG including a plurality of test cases TC will be described.

The test case group TG depicted in FIG. 3 as an example is an aggregate of test cases TC in which the contents of tests for the system software to be tested are described. That is, as depicted in FIG. 3, the test case group TG is a table in which at least one test case TC is described in line units.

The test case group TG includes a test ID field TG1, a procedure field TG2, an expected value field TG3, a category field TG4, and an automatic test execution time field TG5. That is, one test case TC includes a test ID, a procedure, an expected value, a category, and an automatic test execution time. The test case group TG may further include an input field where a test result is input.

A test case ID for identifying the test case TC is set in the test ID field TG1.

A test procedure is set in the procedure field TG2.

An expected value is set in the expected value field TG3. The expected value is a correct test result when the test is conducted according to the procedure described in the procedure field TG2 of the same test case TC. That is, the expected value is defined by the specifications of the system software to be tested and is a test result of the test according to the procedure.

A test category of the test case is set in the category field TG4. Specifically, a test category such as a screen to be tested and test contents is set in the category field TG4.

For example, since a test case TC1 having a test case ID of “1” is a test case for accessing a screen X using an application A, “screen X” as a screen to be tested and “screen transition” as a test content are set as test categories in the category field TG4 of the test case TC1.

In addition, for example, a test case TC5 having a test case ID of “5” is a test case for a screen layout in a case where a wired LAN cable is removed when accessing a screen Y. Therefore, “screen Y” as a screen to be tested, and “screen transition,” “layout,” and “error” as test contents are set as test categories in the category field TG4 of the test case TC5.

The time required in a case where the automatic test based on the test case TC is executed, that is, an automatic test execution time is set in the automatic test execution time field TG5. It should be noted that “impossible to automate” is set in the automatic test execution time field TG5 of the test case TC for which the automatic test may not be executed.

### Configuration of Development Support Device

The development support device 5 acquires the ticket TK associated with the corrected code stored in the application folder 21 of the source code management server 2 from the ticket management server 3, acquires the test case TC corresponding to the test case ID described in the acquired ticket TK from the test case management server 4 as an essential test case, and executes the automatic test based on the essential test case. Then, the development support device 5 stores the corrected code having passed the automatic test in the source code management database DB1.

In addition, the development support device 5 acquires, as a related test case, a test case TC that is related to the essential test case and can be executed within an input test period among the test cases TC stored in the test case management server 4, and executes the automatic test based on the acquired related test case. More specifically, the development support device 5 acquires, as a related test case, a test case TC that includes at least one test category of the essential test case and can be executed and completed within the input test period, and executes the automatic test based on the related test case. Then, the development support device 5 notifies the result of the automatic test to the outside.

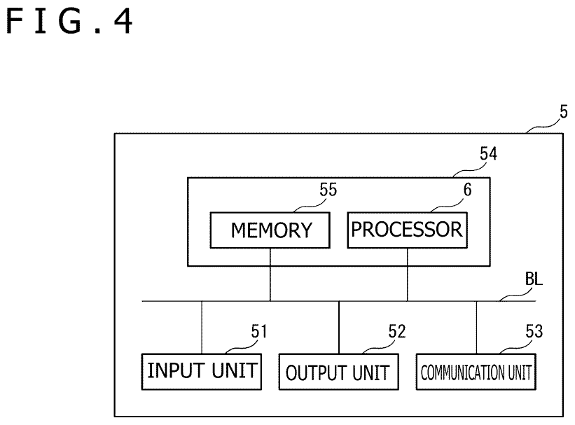

FIG. 4 is a block diagram for depicting a configuration of the development support device 5.

As depicted in FIG. 4, the development support device 5 has an input unit 51, an output unit 52, a communication unit 53, and a control unit 54. The input unit 51, the output unit 52, the communication unit 53, and the control unit 54 are communicably connected to each other via a bus line BL.

The input unit 51 accepts an input operation by the operator of the development support device 5, and outputs an operation signal according to the input operation by the operator to the control unit 54. That is, the input unit 51 configures a period specification operation unit for accepting an operation for specifying a test period to be described later. The input unit 51 can be configured with input devices such as a keyboard and a pointing device. The pointing device is, for example, a mouse and a touch panel.

The output unit 52 outputs a processing result by the control unit 54. Examples of the output unit 52 include a display device and a printer.

The communication unit 53 communicates with external equipment such as servers 2 to 4 via the network N under the control by the control unit 54.

The control unit 54 controls the development support device 5. For example, the control unit 54 executes predetermined processing according to the operation signal input from the input unit 51, and outputs the execution result of the processing to the output unit 52. The control unit 54 includes a memory 55 and a processor 6.

The memory 55 includes a work memory of the processor 6 and a storage device for storing programs and data necessary for the operation of the development support device 5.

The work memory temporarily stores at least a part of the programs read from the storage device. In addition, the work memory temporarily stores the ticket TK acquired from the ticket management server 3 via the communication unit 53 and the test case TC acquired from the test case management server 4.

The storage device stores an operating system (OS) and an automatic test program for allowing the processor 6 to execute automatic test processing described later. That is, the memory 55 having the storage device is a recording medium in which the automatic test program is recorded.

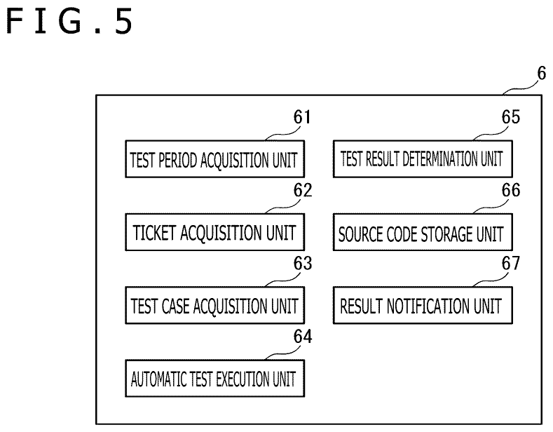

FIG. 5 is a block diagram for depicting a functional configuration of the processor 6.

The processor 6 executes the OS stored in the storage device of the memory 55 to control the development support device 5. Further, the processor 6 executes the automatic test program stored in the storage device of the memory 55 to conduct automatic test processing described later. It should be noted that it may provide at least one processor 6 in the development support device 5, and the number of processors 6 provided in the development support device 5 can be appropriately changed.

As depicted in FIG. 5, the processor 6 has a test period acquisition unit 61, a ticket acquisition unit 62, a test case acquisition unit 63, an automatic test execution unit 64, a test result determination unit 65, a source code storage unit 66, and a result notification unit 67, all of which function by executing the automatic test program.

The test period acquisition unit 61 acquires a test period input by using the input unit 51. The test period is a conduct period of the automatic test related to the target source code.

The ticket acquisition unit 62 acquires from the ticket management server 3 the ticket TK in which a defect that can be eliminated by the corrected code stored in the application folder 21 of the source code management server 2 is described. It should be noted that information indicating the association between the corrected code and the ticket TK in which a defect that can be eliminated by the corrected code is input may be stored in the application folder 21 together with the corrected code. In this case, for example, the ID of the ticket TK corresponding to the corrected code may be stored in the application folder 21 together with the corrected code. In addition, a copy of the ticket TK may be stored in the application folder 21 together with the corrected code. In this case, the ticket acquisition unit 62 may acquire the copy of the ticket TK stored in the application folder 21.

The test case acquisition unit 63 acquires a test case ID input in the test case field T05 of the acquired ticket TK, and acquires a test case TC corresponding to the acquired test case ID from the test case management server 4 as an essential test case. In a case where the ticket TK depicted in FIG. 2 is acquired by the ticket acquisition unit 62, the test case acquisition unit 63 acquires the test case TC3 having a test case ID of “3” as the essential test case. It should be noted that the number of test cases TC acquired as the essential test cases may be two or more.

Further, the test case acquisition unit 63 extracts test cases TC including the same test category as the test category included in the acquired test case TC from the test case group TG stored in the test case management server 4. Then, on the basis of the automatic test execution times included in the extracted test cases TC, the test case acquisition unit 63 acquires test cases TC that are finished within a test period among the extracted test cases TC as related test cases. It should be noted that the test cases TC that are finished within a test period indicate test cases TC all of which can be conducted within the test period in a case where the automatic test based on each of the acquired test cases TC is continuously conducted.

Then, the test case acquisition unit 63 sets the acquired essential test case and related test case as test cases to be conducted.

The automatic test execution unit 64 executes the automatic test based on the test cases TC acquired by the test case acquisition unit 63. That is, the automatic test execution unit 64 executes the automatic test based on the test cases TC to be conducted set by the test case acquisition unit 63.

At this time, the automatic test execution unit 64 constructs a test environment of the system software including the corrected code stored in the application folder 21 and to be tested. Specifically, the automatic test execution unit 64 first fetches and builds the corrected code into the system software to be tested, and generates the system software of the test environment. Then, the automatic test execution unit 64 installs the generated system software into a device of a development environment, and executes the automatic test based on the test cases TC to be conducted by using the device. It should be noted that the device of the development environment may be the development support device 5, or may be another device such as a personal computer (PC) that can be remotely operated by the development support device 5. Thereafter, the automatic test execution unit 64 acquires the result of the automatic test.

The test result determination unit 65 determines the result of the automatic test by the automatic test execution unit 64. Specifically, the test result determination unit 65 determines whether or not the system software to be tested has passed the automatic test based on the test cases TC to be conducted.

It should be noted that the test result determination unit 65 may determine that the system software has passed the automatic test in a case where the same result as the expected value has been obtained in the automatic test based on all of the test cases TC to be conducted. In addition, the test result determination unit 65 may determine that the system software has passed the automatic test in a case where the same result as the expected value has been obtained in the automatic test based on the essential test case.

In a case where the test result determination unit 65 determines that the system software has passed the automatic test, the source code storage unit 66 stores the corrected code in the source code management database DB1 that is a management area.

The result notification unit 67 notifies the result of the automatic test by the test result determination unit 65. For example, the result notification unit 67 notifies the person who conducted the test and the person in charge of development input in the acquired ticket TK of the result of the automatic test by the test result determination unit 65. In a case where the corrected code has been stored in the source code management database DB1 by the source code storage unit 66, the result notification unit 67 may notify the fact that the corrected code has been stored in the source code management database DB1 together with the result of the automatic test. Such notification by the result notification unit 67 may be made by e-mail.

### Automatic Test Processing

FIG. 5 is a flowchart for depicting the automatic test processing executed by the above-described processor 6.

As described above, in a case where the corrected code has been stored in the application folder 21, the processor 6 reads the automatic test program stored in the memory 55 and executes the following automatic test processing.

In the automatic test processing, as depicted in FIG. 5, the test period acquisition unit 61 first acquires the test period input by the operator or the like of the development support device 5 (Step S1). It should be noted that Step S1 may be omitted. That is, it is not necessary to input the test period.

Next, the ticket acquisition unit 62 acquires the ticket TK associated with the corrected code from the ticket management server 3 (Step S2).

Thereafter, the test case acquisition unit 63 acquires the test case TC corresponding to the test case ID input to the ticket TK from the test case management server 4, and acquires the test case TC including the same test category as the test category included in the acquired test case TC from the test case management server 4 (Step S3). That is, the test case acquisition unit 63 acquires the essential test case and the related test case as target test cases. It should be noted that, as described above, in a case where the test period is set, the test case acquisition unit 63 acquires the related test cases all of which are finished within the test period.

Then, the automatic test execution unit 64 constructs a test environment for the system software to be tested, and executes the automatic test based on the test cases TC to be executed acquired in Step S3 (Step S4).

Next, the test result determination unit 65 determines the result of the automatic test by the automatic test execution unit 64 (Step S5). That is, the test result determination unit 65 determines whether or not the system software of the test environment has passed the automatic test.

If it is determined in Step S5 that the system software has not passed the automatic test (Step S5: NO), the processor 6 shifts the processing to Step S7.

If it is determined in Step S5 that the system software has passed the automatic test (Step S5: YES), the source code storage unit 66 stores the corrected code in the source code management database DB1 (Step S6). Then, the processor 6 shifts the processing to Step S7.

In Step S7, the result notification unit 67 notifies the result of the automatic test and whether or not the corrected code has been stored (Step S7).

The automatic test processing is finished by the above procedure.

### Effect of First Embodiment

The development support system 1 according to the embodiment of the present disclosure described above exhibits the following effects.

The development support system 1 includes the source code management server 2, the ticket management server 3, the test case management server 4, and the development support device 5.

The source code management server 2 manages the source codes of the system software.

The ticket management server 3 manages the ticket TK describing the contents of the defect of the system software.

The test case management server 4 manages a plurality of test cases TC related to the system software.

The development support device 5 has the memory 55 and the processor 6.

The processor 6 has the ticket acquisition unit 62, the test case acquisition unit 63, the automatic test execution unit 64, the test result determination unit 65, and the source code storage unit 66.

When the corrected code having corrected the defect among the source codes is stored in a place other than the source code management database DB1 that is a management area, the ticket acquisition unit 62 acquires the ticket TK corresponding to the corrected code from the ticket management server 3. It should be noted that the place other than the source code management database DB1 includes the application folder 21.

The test case acquisition unit 63 acquires target test cases related to the test of the corrected code among the plurality of test cases TC.

The automatic test execution unit 64 executes the automatic test based on the target test cases.

The test result determination unit 65 determines whether or not the system software has passed the automatic test executed by the automatic test execution unit 64.

The source code storage unit 66 does not store the corrected code in the source code management database DB1 when the test result determination unit 65 determines that the system software has not passed the automatic test, and stores the corrected code in the source code management database DB1 when it is determined that the system software has passed the automatic test.

According to such a configuration, since the source code that has passed the automatic test executed by the automatic test execution unit 64 is stored in the source code management database DB1, it is possible to suppress a source code, which may include a defect, from being stored in the source code management database DB1. Thus, it is possible to easily manage the system software in the source code management database DB1.

In the development support system 1, the processor 6 includes the result notification unit 67 for notifying the determination result by the test result determination unit 65.

According to such a configuration, since it is possible to notify the operator and the developer of the development support device 5 of whether or not the corrected code has passed the automatic test, it is possible to enhance the convenience of the development support system 1.

In the development support system 1, each of the plurality of test cases TC includes at least one test category that is a category of a test content. The test case acquisition unit 63 acquires, as target test cases, the essential test case that is the test case TC corresponding to the test case ID included in the ticket TK acquired by the ticket acquisition unit 62 and the related test case that is the test case corresponding to the test category included in the essential test case among the plurality of test cases TC.

According to such a configuration, the essential test case that can determine whether or not the defect has been eliminated and the related test case that includes the same test category as the essential test case are acquired as the target test cases of the automatic test. According to this, it is possible to confirm not only the elimination of the defect but also whether or not a defect similar to the defect exists in the source code of the current system software. Thus, it is possible to find a defect earlier.

In the development support system 1, the automatic test execution time is set to each of the plurality of test cases TC. The test case acquisition unit 63 acquires test cases TC, which are selected from the plurality of test cases TC and all of which can be finished within a predetermined period, on the basis of the automatic test execution time.

According to such a configuration, the test case acquisition unit 63 can acquire the test cases TC that can be finished within the predetermined period. Thus, the automatic test can be finished within the test period.

In the development support system 1, the development support device 5 has the input unit 51 that accepts a period specification operation for specifying a test period that is a predetermined period. The input unit 51 corresponds to the period specification operation unit. The test case acquisition unit 63 acquires the test cases all of which can be completed within the test period.

According to such a configuration, for example, the operator of the development support device 5 can specify a test period, and the test case acquisition unit 63 acquires the test cases TC that can be completed within the test period, so that the automatic test can be completed within the specified test period. Thus, it is possible to enhance the convenience of the development support system 1.

### Second Embodiment

Next, a second embodiment of the present disclosure will be described.

A development support system according to the embodiment of the present disclosure includes a configuration similar to the development support system 1 according to the first embodiment, but is different therefrom in that the operator of the development support device can select a test category used by the test case acquisition unit 63 to acquire a related test case. That is, the development support device according to the embodiment of the present disclosure is different from the development support device 5 according to the first embodiment in that it has a category selection unit for selecting a test category according to an input operation of an operator. It should be noted that, in the following description, parts that are the same or substantially the same as those already described are given the same reference numerals, and the description thereof will be omitted.

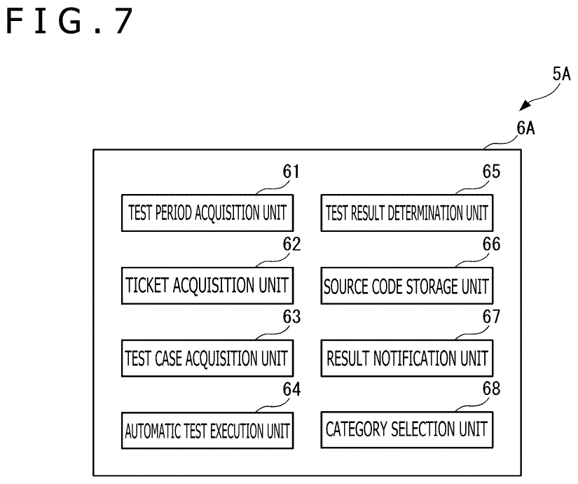

FIG. 7 is a block diagram for depicting a functional configuration of a processor 6A of a development support device 5A provided in the development support system according to the embodiment of the present disclosure.

The development support system according to the embodiment of the present disclosure includes a configuration and functions similar to those of the development support system 1 according to the first embodiment except that the development support device 5A depicted in FIG. 7 is provided instead of the development support device 5 according to the first embodiment. That is, the development support system according to the embodiment of the present disclosure includes the source code management server 2, the ticket management server 3, the test case management server 4, and the development support device 5A.

The development support device 5A includes a configuration and functions similar to those of the development support device 5 except that the processor 6A is provided instead of the processor 6. That is, the development support device 5A has the input unit 51, the output unit 52, the communication unit 53, and the control unit 54, and the control unit 54 include the memory 55 and the processor 6A.

As similar to the processor 6, the processor 6A executes the OS stored in the storage device of the memory 55 to control the development support device 5A. The processor 6A executes the automatic test program stored in the storage device of the memory 55 to conduct automatic test processing described later. It should be noted that it may provide at least one processor 6A in the development support device 5A, and the number of processors 6A provided in the development support device 5A can be appropriately changed.

The processor 6A includes a configuration and functions similar to those of the processor 6 except that a category selection unit 68 is further provided. That is, the processor 6A has the category selection unit 68 in addition to the test period acquisition unit 61, the ticket acquisition unit 62, the test case acquisition unit 63, the automatic test execution unit 64, the test result determination unit 65, the source code storage unit 66, and the result notification unit 67.

The category selection unit 68 allows the output unit 52 to output the test category included in the essential test case acquired by the test case acquisition unit 63, and allows the operator of the development support device 5A to select the test category. Then, the category selection unit 68 selects the test category according to an input operation of the operator to the input unit 51 functioning as the category specification operation unit. Then, the test case acquisition unit 63 acquires the test case including the test category selected by the category selection unit 68 as the related test case.

### Effect of Second Embodiment

The development support system according to the embodiment of the present disclosure described above exhibits the effects similar to those of the development support system 1 according to the first embodiment, and also exhibits the following effects.

In the development support system according to the embodiment of the present disclosure, the development support device 5A includes the input unit 51 that accepts a category specification operation for specifying a test category. The input unit 51 configures the category specification operation unit. The processor 6A has the category selection unit 68 for selecting a test category according to the category specification operation. The test case acquisition unit 63 acquires a test case TC including the test category selected by the category selection unit 68.

According to such a configuration, for example, the operator of the development support device 5A can select a test category of the test case for executing the automatic test, that is, the test case TC acquired as a related test case. Thus, for example, in a case where the test period is short, the operator can select and execute the necessary test category of the automatic test.

### Third Embodiment

Next, a third embodiment of the present disclosure will be described.

A development support system according to the embodiment of the present disclosure includes a configuration similar to that of the development support system 1 according to the first embodiment, but the function of the test case acquisition unit 63 is different. Specifically, the test case acquisition unit 63 according to the embodiment of the present disclosure is different from the test case acquisition unit 63 according to the first embodiment in that, when acquiring a related test case that can be completed within a test period, a test case TC having a test category with a high priority is preferentially acquired as the related test case. It should be noted that, in the following description, parts that are the same or substantially the same as those already described are given the same reference numerals, and the description thereof will be omitted.

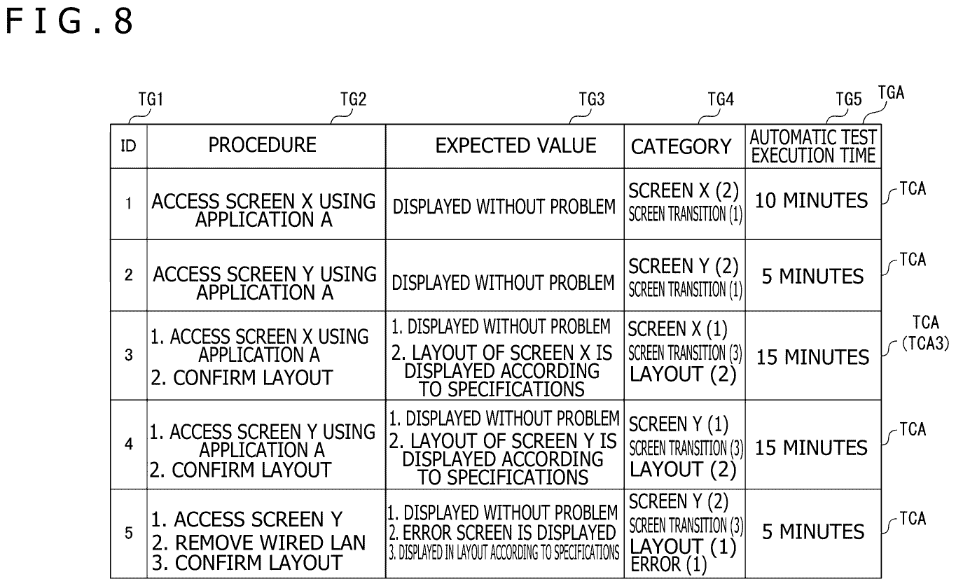

FIG. 8 is a diagram for depicting a test case group TGA according to the embodiment of the present disclosure.

The development support system according to the embodiment of the present disclosure includes a configuration and functions similar to those of the development support system 1 according to the first embodiment. That is, the development support system according to the embodiment of the present disclosure includes the source code management server 2, the ticket management server 3, the test case management server 4, and the development support device 5.

Among these, the test case group TGA depicted in FIG. 8 as an example is stored in the test case management database DB3 of the test case management server 4.

The test case group TGA is an aggregate of a plurality of test cases TCA. As similar to the test case group TG according to the first embodiment, the test case group TGA includes the test ID field TG1, the procedure field TG2, the expected value field TG3, the category field TG4, and the automatic test execution time field TG5. The contents of the plurality of test cases TCA included in the test case group TGA depicted in FIG. 8 as an example is the same as those of the plurality of test cases TC included in the test case group TG depicted in FIG. 3 as an example except for the contents of the category field TG4. That is, the contents of the test category are different between the plurality of test cases TCA and the plurality of test cases TC.

In the category field TG4 of the test case group TGA, the respective test categories of the plurality of test cases TCA are inputted, and the priority of the test category is input in parentheses.

For example, “screen X,” “screen transition,” and “layout” are set as test categories in the test case TCA3 having a test case ID of “3.” Further, “priority 1” with the highest priority is set to “screen X,” “priority 2” is set to “layout,” and “priority 3” with the lowest priority is set to “screen transition.” Such a priority can be set according to the test contents of the test case TCA, and can be input or selected by the operator. Further, a relation between the test category and the priority may be set in a table held by, for example, the test case management server 4 or the development support device 5.

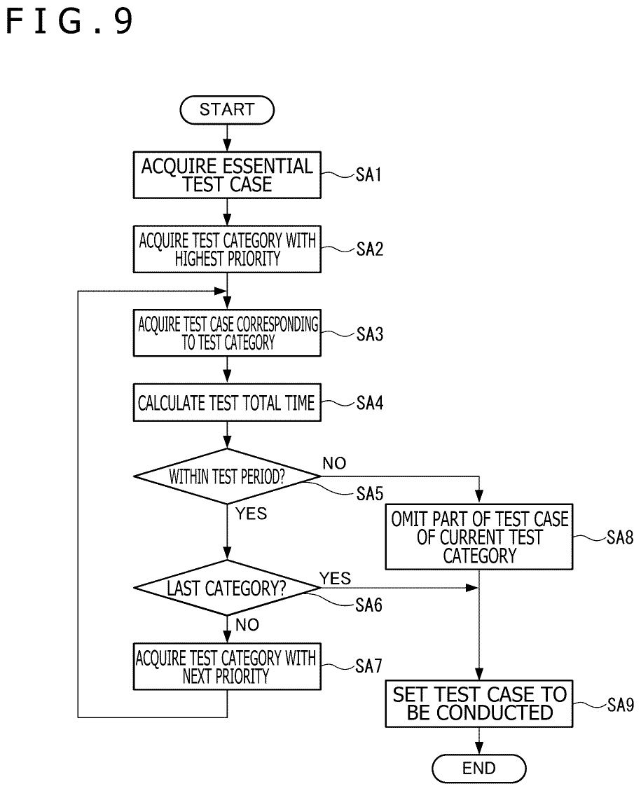

FIG. 9 is a flowchart for depicting test case acquisition processing by the test case acquisition unit 63.

The test case acquisition unit 63 of the processor 6 provided in the development support device 5 executes the test case acquisition processing depicted in FIG. 9 to acquire a test case TCA to be conducted from the test case management server 4. The test case acquisition processing is processing executed in Step S3 of the above automatic test processing.

In the test case acquisition processing, the test case acquisition unit 63 first acquires the test case TCA corresponding to the test case ID included in the ticket TK acquired by the ticket acquisition unit 62 as an essential test case (Step SA1).

Next, the test case acquisition unit 63 acquires the test category with the highest priority from the essential test case (Step SA2). For example, in a case where the above test case TCA3 is acquired as the essential test case, “screen X” to which “priority 1” is set is acquired.

Thereafter, the test case acquisition unit 63 acquires the test case TCA corresponding to the acquired test category from the test case management server 4 as a related test case (Step SA3).

Then, the test case acquisition unit 63 calculates the total time of the automatic test execution time of the essential test case and the automatic test execution time of the related test case acquired in Step SA3 (Step SA4).

Next, the test case acquisition unit 63 determines whether or not the total time calculated in Step SA4 is a time within the test period acquired by the test period acquisition unit 61 (Step SA5).

If it is determined in the determination processing in Step SA5 that the total time is a time within the test period (Step SA5: YES), the test case acquisition unit 63 determines whether or not the currently-acquired test category is the last test category (Step SA6). In other words, the test case acquisition unit 63 determines, in Step SA6, whether or not the currently-acquired test category is the test category with the lowest priority among the test categories included in the essential test case.

If it is determined in the determination processing in Step SA6 that the currently-acquired test category is not the last test category (Step SA6: NO), the test case acquisition unit 63 acquires the test category with the next priority (Step SA7). That is, the test case acquisition unit 63 acquires the test category whose priority is lower by one level than the current test category. Then, the test case acquisition unit 63 returns the processing to Step SA3. Accordingly, in Step SA5, the test case acquisition unit 63 acquires the test case TCA according to the test category included in the essential test case until the total time exceeds the test period.

On the other hand, if it is determined in the determination processing in Step SA5 that the total time is not a time within the test period, the test case acquisition unit 63 omits a part of the test case TCA according to the current test category, and adjusts the total time of the automatic test execution time of the essential test case and the automatic test execution time of the related test case to be within the test period (Step SA8). That is, in Step SA8, the test case acquisition unit 63 omits a part of the test case TCA acquired in the preceding Step SA3. Accordingly, the test case TCA for which the automatic test can be completed within the test period is acquired. Thereafter, the test case acquisition unit 63 shifts the processing to Step SA9.

In addition, in a case where it is determined in the determination processing in Step SA6 that the acquired test category is the last test category (Step SA6: YES), the test case acquisition unit 63 shifts the processing to Step SA9.

In Step SA9, the test case acquisition unit 63 sets the essential test case acquired in Step SA1 and the related test case acquired in Step SA3 as test cases to be conducted for the automatic test by the automatic test execution unit 64 (Step SA9).

Accordingly, the test case acquisition unit 63 finishes the test case acquisition processing.

### Effect of Third Embodiment

The development support system according to the embodiment of the present disclosure described above exhibits the effects similar to those of the development support system 1 according to the first embodiment, and also exhibits the following effects.

In the development support system according to the embodiment of the present disclosure, a priority is set to a test category. The test case acquisition unit 63 preferentially acquires the test case TCA including the test category with a high priority among the plurality of test cases TCA.

According to such a configuration, the automatic test based on the test case TCA including the test category with a high priority can be preferentially executed. Therefore, for example, even in a case where the test period is short, the necessary automatic test can be preferentially executed.

### Modification of Embodiment

The present disclosure is not limited to each of the above-described embodiments, and modifications, improvements, and the like to the extent that it is desirable to be achieved are included in the present disclosure.

In each of the above-described embodiments, the processors 6 and 6A of the development support devices 5 and 5A execute the above-described automatic test processing in a case where the corrected code has been stored in the application folder 21 of the source code management server 2. However, the present disclosure is not limited thereto, and it is not necessary that the source code to be stored in the application folder 21 is the corrected code having corrected the defect. For example, in a case where a new function and a new screen are added to the system software, a source code related to the function or screen may be used.

In each of the above-described embodiments, the source code management server 2, the ticket management server 3, the test case management server 4, and the development support device 5 are configured with devices different from each other. However, the present disclosure is not limited thereto, and at least one of the source code management server 2, the ticket management server 3, the test case management server 4, and the development support device 5 may be integrated with another server or device. For example, the source code management server 2, the ticket management server 3, and the test case management server 4 may be configured with one server.

In each of the above-described embodiments, the source code management server 2 holds the source code management database DB1 for managing source codes, the ticket management server 3 holds the ticket management database DB2 for managing the ticket TK, and the test case management server 4 holds the test case management database DB3 for managing the test case TC. However, the present disclosure is not limited thereto, and it is not necessary for at least one of the servers 2 to 4 to manage the management target by the database. For example, the test case TC may be managed by a file of spreadsheet software, and the ticket TK may be a slip file.

In each of the above-described embodiments, the processors 6 and 6A have the result notification unit 67 for notifying the result of the automatic test. However, the present disclosure is not limited thereto, and the result notification unit 67 may be omitted. In addition, the notification by the result notification unit 67 may be made by means other than e-mail. Further, the notification destination by the result notification unit 67 may not to be the operator and the developer of the development support devices 5 and 5A but may be a source code manager or a test manager.

In each of the above-described embodiments, the test case acquisition unit 63 acquires not only the essential test case but also the related test case, and sets the essential test case and the related test case as test cases to be conducted for the automatic test. However, the present disclosure is not limited thereto, and the test case acquisition unit 63 may acquire the essential test case and set the acquired essential test case as a test case to be conducted for the automatic test.

In each of the above-described embodiments, the test cases TC and TCA include the automatic test execution time that is a time required to complete the execution in a case where the automatic test based on the test cases TC and TCA is executed. However, the present disclosure is not limited thereto, and it is not necessary to include the automatic test execution time in the test cases TC and TCA.

In each of the above-described embodiments, the test case acquisition unit 63 acquires the test case that can be completed within the test period acquired according to a period specification operation for the input unit 51 functioning as the period specification operation unit. However, the present disclosure is not limited thereto, and it is not necessary to input the test period as described above. For example, in a case where the test period is not acquired, the test case acquisition unit 63 may acquire all of the test cases including at least one test category among the test categories included in the essential test case as related test cases.

### SUMMARY OF PRESENT DISCLOSURE

A summary of the present disclosure will be additionally described in the following.

[1]

A development support system including:
a source code management server that has a management area for managing source codes of system software;
a ticket management server that manages a ticket describing contents of a defect of the system software;
a test case management server that manages a plurality of test cases related to the system software; and
a development support device that has a memory and a processor, in which
the processor includes
a ticket acquisition unit that acquires, when a code in which a defect has been corrected among the source codes is stored in a place other than the management area, the ticket corresponding to the corrected code from the ticket management server,
a test case acquisition unit that acquires a target test case related to a test of the corrected code among the plurality of test cases,
an automatic test execution unit that executes an automatic test based on the target test case,
a test result determination unit that determines whether or not the system software has passed the automatic test executed by the automatic test execution unit, and
a source code storage unit that does not store the corrected code in the management area when it is determined by the test result determination unit that the automatic test has not been passed, and stores the corrected code in the management area when it is determined that the automatic test has been passed.

According to such a configuration, since the source code that has passed the automatic test executed by the automatic test execution unit is stored in the management area, it is possible to suppress a source code, which may include a defect, from being stored in the management area. Thus, it is possible to easily manage the system software in the management area.

[2]

The development support system according to [1], in which
the processor includes a result notification unit that notifies a determination result by the test result determination unit.

According to such a configuration, since whether or not the corrected code has passed the automatic test is notified to the operator of the development support device, it is possible to enhance the convenience of the development support system.

[3]

The development support system according to [1] or [2], in which
each of the plurality of test cases includes at least one test category that is a category of a test content, and
the test case acquisition unit acquires, as the target test cases, an essential test case that is a test case corresponding to a test case ID included in the ticket acquired by the ticket acquisition unit, and a related test case that is a test case corresponding to the test category included in the essential test case among the plurality of test cases.

According to such a configuration, the essential test case that can determine whether or not the defect has been eliminated and the related test case that includes the same test category as the essential test case are acquired as the target test cases of the automatic test. According to this, it is possible to confirm not only the elimination of the defect but also whether or not a defect similar to the defect exists in the source code of the current system software. Thus, it is possible to find a defect earlier.

[4]

The development support system according to [3], in which
the development support device includes a category specification operation unit that accepts a category specification operation for specifying the test category,
the processor has a category selection unit that selects the test category according to the category specification operation, and
the test case acquisition unit acquires a test case including the test category selected by the category selection unit.

According to such a configuration, for example, the operator of the development support device can select the test category of the test case for executing the automatic test. Thus, for example, in a case where the test period is short, the operator can select and execute the test category of the necessary automatic test.

[5]

The development support system according to [3], in which
a priority is set to the test category, and
the test case acquisition unit preferentially acquires a test case including the test category with a high priority among the plurality of test cases.

According to such a configuration, the automatic test based on the test case including the test category with a high priority can be preferentially executed. Therefore, for example, even in the case where the test period is short, the necessary automatic test can be preferentially executed.

[6]

The development support system according to any one of [3] to [5], in which
an automatic test execution time is set to each of the plurality of test cases, and
the test case acquisition unit acquires test cases which are selected from the plurality of test cases and all of which are possible to be finished within a predetermined period, on the basis of the automatic test execution time.

According to such a configuration, the test case acquisition unit can acquire the test cases that can be finished within the predetermined period. Thus, the automatic test can be finished within the test period.

[7]

The development support system according to [6], in which
the development support device has a period specification operation unit that accepts a period specification operation for specifying the predetermined period, and
the test case acquisition unit acquires test cases all of which are possible to be completed within the predetermined period corresponding to the period specification operation.

According to such a configuration, for example, the operator of the development support device can specify a test period, and the test case acquisition unit acquires the test cases that can be completed within the test period, so that the automatic test can be completed within the specified test period. Thus, it is possible to enhance the convenience of the development support system.

[8]

A development support device including:
a memory; and
a processor, in which
the processor includes
a ticket acquisition unit that acquires, when a code in which a defect has been corrected among source codes configuring system software is stored in a place other than a management area, a ticket corresponding to the corrected code,
a test case acquisition unit that acquires a target test case related to a test of the corrected code among a plurality of test cases,
an automatic test execution unit that executes an automatic test based on the target test case,
a test result determination unit that determines whether the system software has passed the automatic test executed by the automatic test execution unit, and
a corrected code storage unit that stores the corrected code in the management area when it is determined by the test result determination unit that the automatic test has been passed.

According to such a configuration, effects similar to those of the development support system can be exhibited.

1. A development support system comprising:
a source code management server that has a management area for managing source codes of system software;
a ticket management server that manages a ticket describing contents of a defect of the system software;
a test case management server that manages a plurality of test cases related to the system software; and
a development support device that has a memory and a processor, wherein the processor comprises:
a ticket acquisition unit that acquires, when a code in which a defect has been corrected among the source codes is stored in a place other than the management area, the ticket corresponding to the corrected code from the ticket management server;
a test case acquisition unit that acquires a target test case related to a test of the corrected code among the plurality of test cases;
an automatic test execution unit that executes an automatic test based on the target test case;
a test result determination unit that determines whether or not the system software has passed the automatic test executed by the automatic test execution unit; and
a source code storage unit that does not store the corrected code in the management area when it is determined by the test result determination unit that the automatic test has not been passed, and stores the corrected code in the management area when it is determined that the automatic test has been passed.

2. The development support system according to claim 1, wherein the processor comprises a result notification unit that notifies a determination result by the test result determination unit.

3. The development support system according to claim 1, wherein:
each of the plurality of test cases comprises at least one test category that is a category of a test content; and
the test case acquisition unit acquires, as the target test case, an essential test case that is a test case corresponding to a test case identification included in the ticket acquired by the ticket acquisition unit, and a related test case that is a test case corresponding to the test category included in the essential test case among the plurality of test cases.

4. The development support system according to claim 3, wherein:
the development support device comprises a category specification operation unit that accepts a category specification operation for specifying the test category;
the processor has a category selection unit that selects the test category according to the category specification operation; and
the test case acquisition unit acquires a test case including the test category selected by the category selection unit.

5. The development support system according to claim 3, wherein:
a priority is set to the test category; and
the test case acquisition unit preferentially acquires a test case including the test category with a high priority among the plurality of test cases.

6. The development support system according to claim 3, wherein:
an automatic test execution time is set to each of the plurality of test cases; and
the test case acquisition unit acquires test cases which are selected from the plurality of test cases and all of which are possible to be finished within a predetermined period, on a basis of the automatic test execution time.

7. The development support system according to claim 6, wherein:
the development support device has a period specification operation unit that accepts a period specification operation for specifying the predetermined period; and
the test case acquisition unit acquires test cases all of which are possible to be completed within the predetermined period corresponding to the period specification operation.

8. A development support device comprising:
a memory; and
a processor, wherein the processor comprises:
a ticket acquisition unit that acquires, when a code in which a defect has been corrected among source codes configuring system software is stored in a place other than a management area, a ticket corresponding to the corrected code;
a test case acquisition unit that acquires a target test case related to a test of the corrected code among a plurality of test cases;
an automatic test execution unit that executes an automatic test based on the target test case;
a test result determination unit that determines whether the system software has passed the automatic test executed by the automatic test execution unit; and
a corrected code storage unit that stores the corrected code in the management area when it is determined by the test result determination unit that the automatic test has been passed.
